(19) United States
(12) Patent Application Publication
(10) Pub. No.: US 2015/0364831 A1
(43) Pub. Date: Dec. 17, 2015

(54) ARRAY ANTENNA

(71) Applicant: NIHON DENGYO KOSAKU CO., LTD., Tokyo (JP)

(72) Inventors: Zhanghuan LI, Tokyo (JP); Takeshi SHIMURA, Tokyo (JP)

(73) Assignee: NIHON DENGYO KOSAKU CO., LTD., Tokyo (JP)

(21) Appl. No.: 14/763,085

(22) PCT Filed: Dec. 4, 2013
(86) PCT No.: PCT/JP2013/082643

§ 371 Date: Jul. 23, 2015

(30) Foreign Application Priority Data
Jan. 24, 2013 (JP) 2013-011127

(51) Int. Cl. H01Q 21/00; H01Q 9/16; H01Q 1/42

(52) U.S. Cl. CPC H01Q 21/0006; H01Q 1/42; H01Q 9/16

(57) ABSTRACT

In this array antenna, if (a) a pair of antennas (130) are used and transmission signals having the same phase are fed in parallel via two secondary cables (33) branching off of a main cable (32), letting Z represent the impedance of the main cable (32), the impedance of each secondary cable (33) and the input impedance of each antenna (130) is set to 2Z; if (b) a set of three antennas (130) is used, the impedance of each secondary cable (33) and the input impedance of each antenna (130) is set to 3Z; and if (c) a set of N antennas (130) is used, the impedance of each secondary cable (33) and the input impedance of each antenna (130) is set to N×Z. In each case, the impedances match over a wide frequency band.

### TECHNICAL FIELD

The present invention relates to an array antenna.

### BACKGROUND ART

In a base station antenna for mobile communication (base station antenna), plural sector antennas, each of which radiates radio frequency for a sector being set corresponding to a direction of radiating radio frequency, are used in combination. As the sector antenna, an array antenna in which antenna elements, such as dipole antennas, are arranged in an array is used.

Patent Document 1 describes a 60° beam antenna apparatus that includes: first and second dipole antennas having lengths of about λ/2 (λ is the wavelength of the center frequency of the request frequency band) and arranged in parallel at a spacing of about λ/2; and a feeding unit having a main feeding line and first and second branched feeding lines which branched from the main feeding line and are connected to feeding points of dipole antennas, respectively, wherein the characteristic impedance of the main feeding line is set to about 50Ω, and the characteristic impedance of the first and second branched feeding lines is set to about 100Ω.

### CITATION LIST

### Patent Literature

Patent Document 1: Japanese Patent Application Laid-Open Publication No. 2006-203428

### SUMMARY OF INVENTION

### Technical Problem

In the array antenna, plural antenna elements are fed in parallel in some cases. At this time, impedance matching is required between the antenna elements and the feeding lines.

An object of the present invention is to provide an array antenna capable of achieving impedance matching with ease in a wide band.

### Solution to Problem

To achieve the above-described object, an array antenna to which the present invention is applied includes: a first feeding line having a first impedance; N second feeding lines branching off from the first feeding line; and N antennas, each of which has a second impedance that is set based on N times the first impedance, the N antennas being connected to the respective N second feeding lines, wherein N is an integer not less than 2.

According to this configuration, it is possible to achieve impedance matching with ease, as compared to a case in which impedance matching is carried out by a transformer or the like.

The antenna in the array antenna configured like this includes a pair of element sections, each of which is configured with a conductive material including a curved line at an edge thereof, the element sections being arranged at symmetrical positions with respect to a predetermined axis at a predetermined distance, and the second impedance is set by a shape thereof.

According to this configuration, the impedance can be set with ease, as compared to a case in which the present configuration is not provided.

Moreover, the antenna in the array antenna configured like this further includes another pair of element sections each configured with a conductive material including a curved line at an edge thereof, the element sections being arranged at symmetrical positions with respect to a predetermined axis at a predetermined distance, and the another pair of element sections is able to transmit and receive a polarization orthogonal to a polarization received and transmitted from and to the pair of element sections.

According to this configuration, it is possible to configure a downsized antenna for dual polarization, as compared to a case in which the present configuration is not provided.

Still further, the antenna in the array antenna configured like this includes a patch antenna having a first conductor, a second conductor and one of a dielectric or an air layer between the first conductor and the second conductor, and the second impedance is set by a position of feeding to the first conductor.

According to this configuration, the impedance can be set with ease, as compared to a case in which the present configuration is not provided.

Then, a radome that contains the array antenna is further included.

According to this configuration, it is possible to provide an array antenna capable of achieving impedance matching with ease and obtaining wide-band frequency characteristics.

### Advantageous Effects of Invention

According to the present invention, it is possible to provide an array antenna capable of achieving impedance matching with ease in a wide band.

### BRIEF DESCRIPTION OF DRAWINGS

FIGS. 1A and 1B are diagrams showing an example of an overall configuration of a base station antenna for mobile communication, to which a first exemplary embodiment is applied;

FIG. 2 is a diagram showing an example of a configuration of an array antenna in the first exemplary embodiment;

FIGS. 3A and 3B are diagrams illustrating a configuration of an antenna in the first exemplary embodiment;

FIGS. 4A and 4B are diagrams illustrating a configuration of a dipole antenna, which is paired with a dipole antenna in FIGS. 3A and 3B for dual polarization, in the first exemplary embodiment;

FIG. 5 is a diagram illustrating an example of methods of feeding to the antenna in the array antenna;

FIGS. 6A to 6C are diagrams illustrating relation among impedances of a main cable and secondary cables and an input impedance of the antenna in a case where the first exemplary embodiment is applied;

FIG. 7 is a diagram illustrating relation among impedances of a main cable and secondary cables and an input impedance of the antenna in a case where the first exemplary embodiment is not applied;

FIG. 8 is a diagram illustrating a model used for performing simulation of characteristics of the antenna;

FIG. 9 is a diagram showing return loss (dB) characteristics of the antenna in the first exemplary embodiment, which is obtained by the simulation model shown in FIG. 8;

FIG. 10 is a diagram showing a horizontal-plane beam width of the antenna in the first exemplary embodiment, which is obtained by the simulation model shown in FIG. 8;

FIG. 11 is a plan view illustrating a configuration of a dipole antenna in a second exemplary embodiment;

FIG. 12 is a diagram showing return loss (dB) characteristics of the antenna in the second exemplary embodiment;

FIG. 13 is a plan view illustrating a configuration of a dipole antenna in a third exemplary embodiment;

FIG. 14 is a plan view illustrating a configuration of a dipole antenna in a fourth exemplary embodiment;

FIG. 15 is a diagram showing an example of a configuration of an array antenna capable of radiating vertical polarization in a fifth exemplary embodiment;

FIGS. 16A and 16B are diagrams showing an example of a configuration of an array antenna capable of radiating horizontal polarization in a sixth exemplary embodiment;

FIG. 17 is a diagram showing an example of a configuration of a bi-directional array antenna capable of in a seventh exemplary embodiment; and

FIGS. 18A to 18C are diagrams illustrating a configuration of an antenna in an eighth exemplary embodiment.

### DESCRIPTION OF EMBODIMENTS

Hereinafter, exemplary embodiments according to the present invention will be described in detail with reference to attached drawings.

### First Exemplary Embodiment

### Base Station Antenna 1

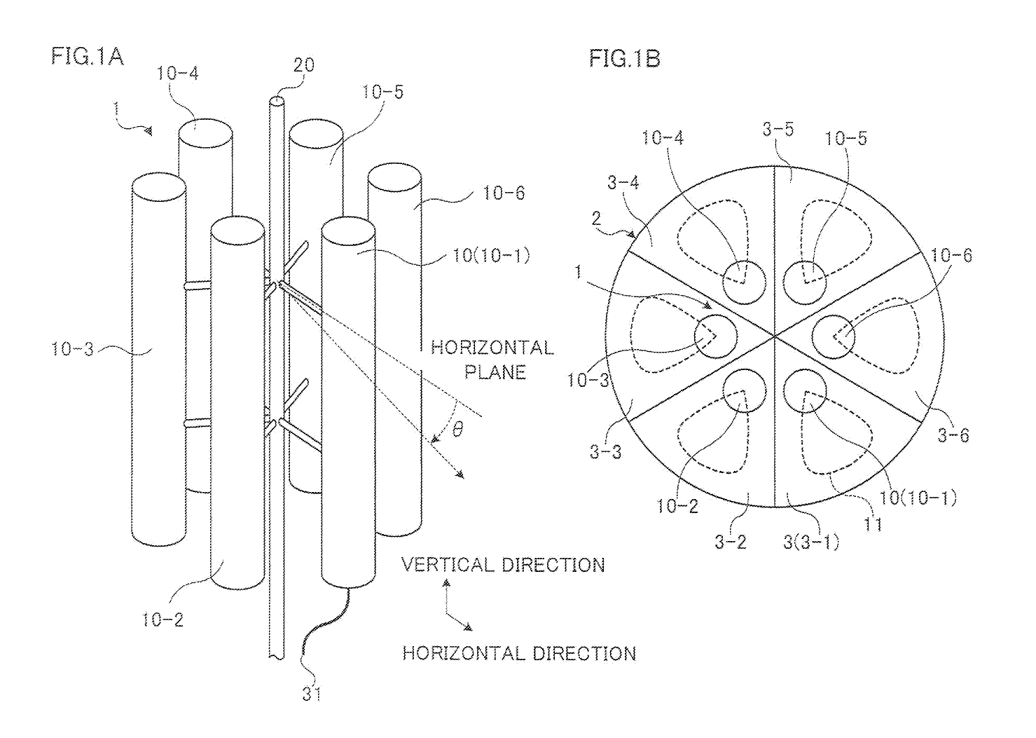

FIGS. 1A and 1B are diagrams showing an example of an overall configuration of a base station antenna 1 for mobile communication, to which the first exemplary embodiment is applied. FIG. 1A is a perspective view of the base station antenna 1, and FIG. 1B is a diagram illustrating an installation example of the base station antenna 1.

The base station antenna 1 includes, as shown in FIG. 1A, plural array antennas 10-1 to 10-6 held by, for example, a tower 20. Then, as shown in FIG. 1B, the base station antenna 1 causes the radio frequency to reach inside of a cell 2. In other words, the cell 2 is a range in which the radio frequency transmitted by the base station antenna 1 reach, and a range in which the base station antenna 1 receives the radio frequency.

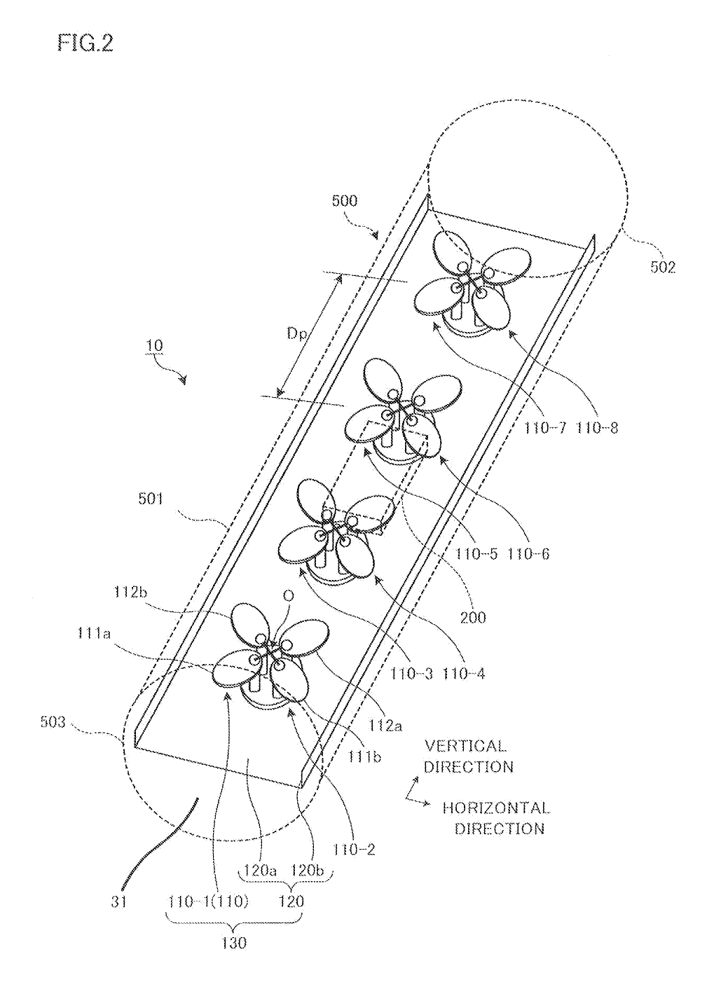

Each of the array antennas 10-1 to 10-6 has a cylindrical radome (refer to radome 500 in FIG. 2 to be described later) on the outside thereof, and a center axis of the cylindrical radome 500 is provided vertical to the ground.

As shown in FIG. 1B, the cell 2 includes plural sectors 3-1 to 3-6 that are provided by angular division on the horizontal plane. The sectors 3-1 to 3-6 are provided corresponding to the six array antennas 10-1 to 10-6 of the base station antenna 1, respectively. That is, in each of the array antennas 10-1 to 10-6, a main lobe 11 with a large electric field of output radio frequency is in the direction of corresponding one of the sectors 3-1 to 3-6.

Here, the array antennas 10-1 to 10-6 are collectively represented as an array antenna 10, when not being distinguished from one another. Moreover, the sectors 3-1 to 3-6 are collectively represented as a sector 3, when not being distinguished from one another.

Note that the base station antenna 1 shown as an example in FIGS. 1A and 1B includes the six array antennas 10-1 to 10-6 and the sectors 3-1 to 3-6 corresponding thereto. However, the array antenna 10 and the sector 3 may be of a number other than six predetermined in advance. Moreover, in FIG. 1A, the sector 3 is configured by dividing the cell 2 into 6 equal parts (center angle is 60°); however, the sector 3 may not be divided equally and any one sector 3 may be configured widely or narrowly as compared to another sector 3.

Then, each array antenna 10 is connected to a transmission and reception cable 31 that transmits transmission signals and reception signals to a dipole antenna (refer to dipole antennas 110-1 to 110-8 in FIG. 2 to be described later, represented as a dipole antenna 110 when not being distinguished from one another) included by the array antenna 10.

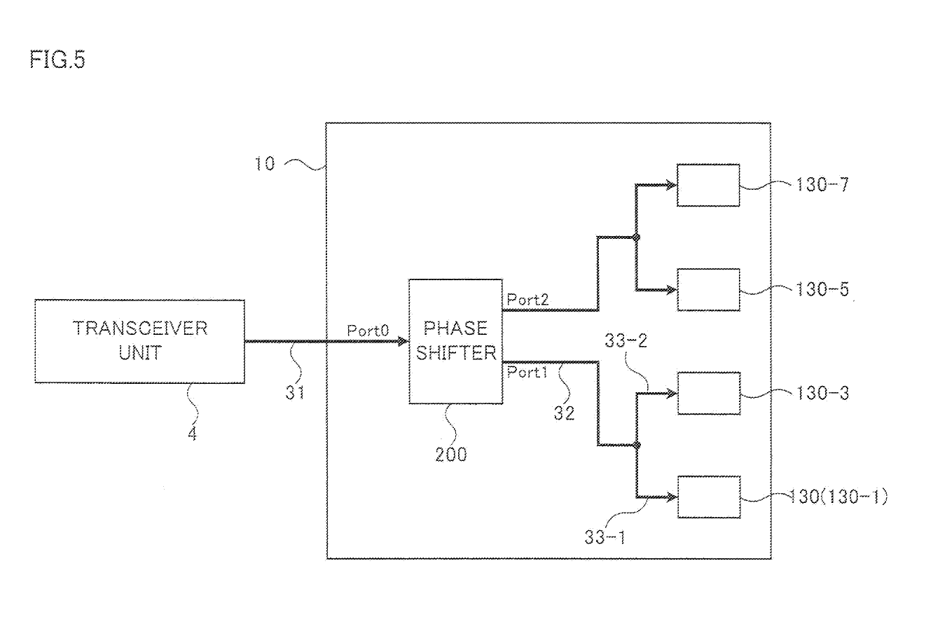

The transmission and reception cable 31 is connected to a transceiver unit 4 (refer to FIG. 5 to be described later) that is provided in the base station (not shown) to generate the transmission signals and receive the reception signals. The transmission and reception cable 31 is, for example, a coaxial cable.

In FIG. 1A, the transmission and reception cable 31 is illustrated with the array antenna 10-1. Though, similar to the array antenna 10-1, other array antennas 10-2 to 10-6 also include the transmission and reception cables 31, illustration thereof is omitted.

Note that, hereinafter, description will be given based on the premise that the base station antenna 1 transmits the radio frequency; however, owing to reversibility of the antenna, the base station antenna 1 is able to receive the radio frequency. In the case of receiving the radio frequency, flow of the signals may be reversed by assuming, for example, the transmission signals as the reception signals.

Moreover, the array antenna 10 includes a phase shifter 200 (refer to FIG. 5 to be described later) for feeding the plural dipole antennas 110 included by the array antenna 10 with the transmission signals having differentiated phases. By shifting the phases of the transmission signals to be fed to the plural dipole antennas 110, the radiating angle of the radio frequency (beam) radiated from the array antenna 10 is tilted by the angle θ (assumed as a beam tilt angle θ) from the horizontal plane to the aboveground direction. This sets the radio frequency not to reach out of the cell 2.

### <Array Antenna 10>

FIG. 2 is a diagram showing an example of a configuration of the array antenna 10 in the first exemplary embodiment. In FIG. 2, the array antenna 10 is laid down, and shown in a perspective view as viewed laterally from an angle.

The array antenna 10 includes: a reflector 120; the plural (here, as an example, 8) dipole antennas 110-1 to 110-8 arranged on the reflector 120; and the phase shifter 200 that feeds each of the dipole antennas 110-1 to 110-8 with the transmission signals while shifting the phases thereof. Further, the array antenna 10 includes a radome 500 that contains the reflector 120, the dipole antennas 110-1 to 110-8 and the phase shifter 200 so as to enclose thereof. In FIG. 2, the radome 500 is indicated by broken lines to let the reflector 120 and the dipole antennas 110-1 to 110-8 provided inside the radome 500 be seen. Note that, in FIG. 2, the phase shifter 200 is indicated by broken lines because the phase shifter 200 is provided on a side of the reflector 120 that is opposite to the side on which the dipole antennas 110-1 to 110-8 are provided.

Each of the odd-numbered dipole antennas 110-1, 110-3, 110-5 and 110-7 includes a pair of elliptic element sections 111a and 112a, in which the direction of the major axis is shifted 45° from the vertical direction. The odd-numbered dipole antennas 110-1, 110-3, 110-5 and 110-7 transmit and receive polarization shifted 45° from the vertical direction. Note that, as an example, the element sections 111a and 112a are provided so that the front surfaces thereof are parallel to a front reflection section 120a of the reflector 120, and arranged at a position symmetric with respect to the point O.

Each of the even-numbered dipole antennas 110-2, 110-4, 110-6 and 110-8 includes another pair of elliptic element sections 111b and 112b, in which the direction of the major axis is shifted −45° from the vertical direction. The even-numbered dipole antennas 110-2, 110-4, 110-6 and 110-8 transmit and receive polarization shifted −45° from the vertical direction. As an example, the element sections 111b and 112b are also provided so that the front surfaces thereof are parallel to a front reflection section 120a of the reflector 120, and arranged at a position symmetric with respect to the point O.

Then, the dipole antennas 110-1 and 110-2 are combined so that the point O on which the element sections 111a and 112a of the dipole antenna 110-1 are symmetrically arranged is in common with the point O on which the element sections 111b and 112b of the dipole antenna 110-2 are symmetrically arranged, to thereby configure a pair. Further, the dipole antennas 110-3, 110-5 and 110-7 are combined with the dipole antennas 110-4, 110-6 and 110-8, respectively, in a similar manner, to thereby configure pairs.

This allows the array antenna 10 to achieve dual polarization capable of transmitting and receiving ±45° polarization.

Note that the element sections 111a and 111b are collectively represented as an element section 111 when not being distinguished from each other, and the element sections 112a and 112b are collectively represented as an element section 112 when not being distinguished from each other.

These dipole antennas 110-1 to 110-8 operate independently.

Accordingly, hereinafter, description will be given by taking one of the dipole antennas 110-1 to 110-8 as the dipole antenna 110.

Note that, in FIG. 2, it was assumed that the ±45° radio frequency are transmitted and received; however, it becomes possible to transmit and receive radio frequency of horizontal polarization and vertical polarization by rotating the two dipole antennas 110 having been paired 45° around the point O.

The reflector 120 reflects the radio frequency transmitted from the dipole antenna 110, and also holds the dipole antenna 110. In FIG. 2, the four pairs, each of which is configured with two dipole antennas 110, are arranged on the reflector 120 with a distance of Dp, to thereby configure the array (array antenna 10).

In the reflector 120, the front reflection section 120a, which the element sections 111 and 112 of the dipole antennas 110 face, is flat. Both end portions of the reflector 120 in the direction intersecting the array direction of the dipole antenna 110 are bent toward the dipole antenna 110 to become side reflection sections 120b. The side reflection sections 120b having been bent define a beam width within the horizontal plane of the array antenna 10.

Note that, in FIG. 2, the side reflection sections 120b are bent toward the dipole antenna 110; however, the side reflection sections 120b may be bent toward the opposite side of the dipole antenna 110. Moreover, in FIG. 2, one side reflection section 120b is provided to each of the end portions of the reflector 120; however, plural side reflection sections 120b may be provided.

Since the side reflection sections 120b define the beam width within the horizontal plane of the array antenna 10, setting may be carried out to obtain a predetermined beam width within the horizontal plane.

The reflector 120 is configured with a conductor, such as aluminum or copper.

In FIG. 2, the reflector 120 is provided in common to the eight dipole antennas 110-1 to 110-8; however, it may be considered that the reflector 120 is divided for each and every dipole antenna 110 or each and every pair of two dipole antennas 110.

Here, the dipole antenna 110 and the reflector 120 corresponding thereto are inclusively referred to as an antenna 130. In the case of two dipole antennas 110 having been paired, the pair of dipole antennas 110 and the reflector 120 corresponding thereto are inclusively referred to as the antenna 130.

The phase shifter 200 will be described later.

The radome 500 includes a cylinder 501, an upper lid 502 that covers an end portion on the upper side of the cylinder 501, and a lower lid 503 that covers an end portion on the lower side of the cylinder 501. The radome 500 contains the antenna 130 inside thereof.

The lower lid 503 of the radome 500 is provided with a connector (not shown), and the transmission and reception cable 31 for receiving and transmitting the transmission signals and the reception signals from and to the dipole antenna 110 is connected thereto. Note that, in FIG. 2, illustration of connection between the transmission and reception cable 31 and the dipole antenna 110 is omitted.

The radome 500 is configured with an insulating resin, such as FRP (fiber reinforced plastics).

Note that the array antenna 10 shown in FIG. 2 is configured with eight dipole antennas 110; however, the number of dipole antennas 110 is not limited to eight, and may be any predetermined number.

Moreover, the array antenna 10 shown in FIG. 2 is configured with a single array including eight dipole antennas 110; however, the array antenna 10 may be configured by arranging multiple arrays.

Further, in FIG. 2, it was assumed that the radome 500 included by the array antenna 10 was the cylinder 501 provided with the upper lid 502 and the lower lid 503; however, the cylinder 501 may be a tube with a rectangular cross section, and one side of the cross section may be an arc shape.

### <Configuration of Array Antenna 130>

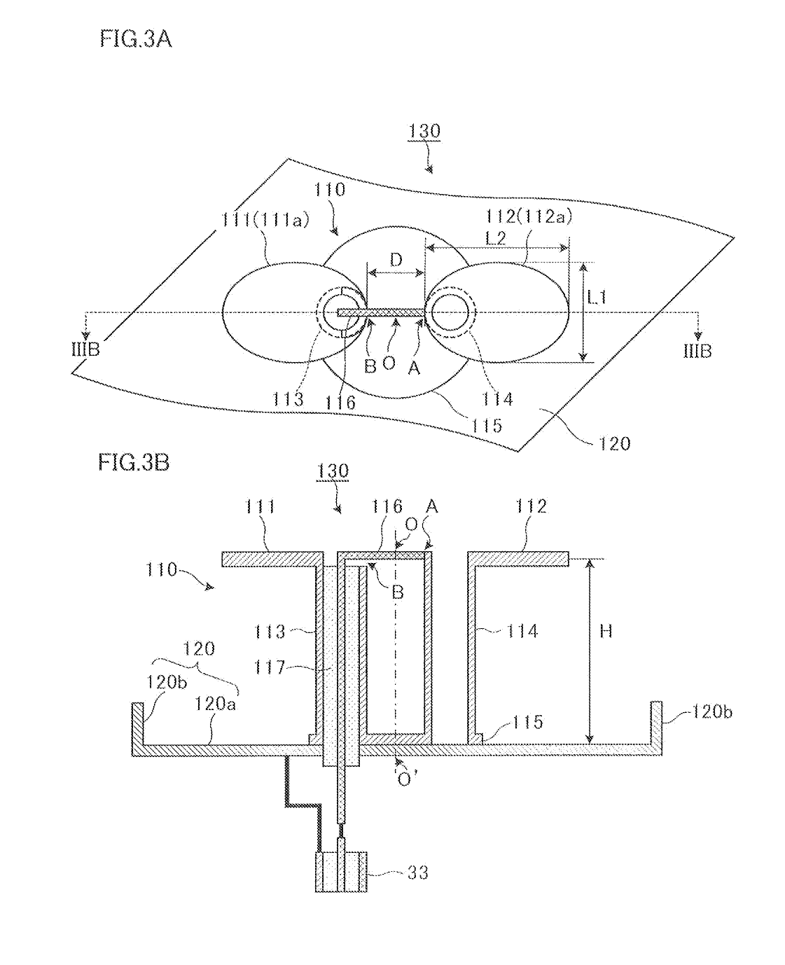

FIGS. 3A and 3B are diagrams illustrating a configuration of the antenna 130 in the first exemplary embodiment. FIG. 3A is a plan view, and FIG. 3B is a cross-sectional view at the IIIB-IIIB line in FIG. 3A. The antenna 130 includes the dipole antenna 110 and the reflector 120.

The dipole antenna 110 includes: the above-described element sections 111 and 112; a leg sections 113 and 114 extending from the element sections 111 and 112, respectively; and a stage section 115 to which the leg sections 113 and 114 are fixed. Note that, though the leg sections 113, 114 and the stage section 115 may not necessarily be provided, description will be given on the assumption that the dipole antenna 110 includes the leg sections 113, 114 and the stage section 115 in the first exemplary embodiment.

Each of the element sections 111 and 112 of the dipole antenna 110 is, as shown in FIG. 3A, a member configured with a conductive material enclosed by an elliptical edge having a minor axis L1 and a major axis L2. The element section 111 and the element section 112 are symmetrically arranged with respect to the point O, and face at a distance D so that the major axes L2 thereof are arranged in line with each other.

Then, as shown in FIG. 3B, the element section 111 is provided with a circular opening at the side of the point O, and the leg section 113 in a cylindrical shape is connected to the opening. The element section 112 is also provided with a circular opening at the side of the point O, and the leg section 114 in a cylindrical shape is connected to the opening. Note that the opening may not be provided to the element section 112, and the leg section 114 may have a cylindrical columnar shape.

The leg sections 113 and 114 of the dipole antenna 110 are connected to the stage section 115 having a circular front surface shape. Note that, in the stage section 115, an opening is provided to face the cylindrical leg section 113. In other words, a cylindrical hollow portion is provided from the opening in the element section 111 to the opening in the stage section 115.

In the first exemplary embodiment, the element sections 111 and 112, the leg sections 113 and 114, and the stage section 115 are configured with a conductive material as a single piece. Note that each of the element sections 111 and 112, the leg sections 113 and 114, and the stage section 115 may be individually or partially configured as a single piece, and assembled by screws or the like.

The element sections 111 and 112, the leg sections 113 and 114, and the stage section 115 are configured with metal, such as copper or aluminum, or an alloy containing those metals.

The stage section 115 is fixed to the front reflection section 120a of the reflector 120 by not-shown screws or the like. The surfaces of the element sections 111 and 112 of the dipole antenna 110 are configured to be parallel to the front reflection section 120a of the reflector 120.

Note that the distance from the surface of the reflector 120 on the dipole antenna 110 side to the center in the thickness direction of the element sections 111 and 112 is regarded as the height H.

In the cylindrical hollow portion running from the opening of the element section 111 to the opening of the stage section 115, an insulator 117 including a conductor 116 at the center thereof is embedded. Note that the insulator 117 may be embedded in the entire hollow portion or in a part thereof.

Then, an end portion of the conductor 116 on the element section 116 side is bent 90° to be connected to an end portion of the element section 112 in proximity to the point O (the part indicated by arrow A). Note that the connection is conducted by soldering, for example.

An end portion of the conductor 116 on the stage section 115 side is connected to an inner conductor of a secondary cable 33 (a secondary cable 33-1 or a secondary cable 33-2 in FIG. 5 to be described later, and represented as a secondary cable 33) through an opening provided to the reflector 120. Moreover, the reflector 120 is connected to an outer conductor of the secondary cable 33.

The conductor 116 may be a conductor wire having a circular cross section; however, since such a wire is less likely to be bent 90°, the conductor 116 may be configured by cutting a metal plate into an L-shape. The conductor 116 is configured with metal, such as copper or aluminum, or an alloy containing those metals.

The insulator 117 is configured with, for example, polytetrafluoroethylene that is excellent in high frequency characteristics.

Note that, to prevent the conductor 116 that has been bent 90° from contacting the element section 112, it is preferable to cut down an end portion of the element section 112 on the point O side (the part indicated by arrow B) toward the reflector 120.

In the dipole antenna 110, for example, the minor axis L1 of the element sections 111 and 112 is 21 mm, the major axis L2 thereof is 30 mm, and the distance D between the element sections 111 and 112 is 12 mm. The height H from the center in the thickness direction of the element sections 111 and 112 to the reflector 120 is 38.5 mm.

The height H is set to about ¼ wavelength in the case where the center frequency fc of the array antenna 10 is set to 2 GHz. Accordingly, in the case of being viewed from the element sections 111 and 112, the element section 111 and the element section 112 are short-circuited on the stage section 115, but a current does not flow.

Note that, though the leg sections 113 and 114 were supposed to have the cylindrical or cylindrical-columnar shape, the outer shape may not be limited to the cylindrical or cylindrical-columnar shape, and may be a rectangular-columnar shape, a tapered shape, and so forth.

In the case where the element sections 111 and 112, the leg sections 113 and 114, and the stage section 115 are integrally molded by a method such as die casting, the leg sections 113 and 114 may have a shape that is easily molded.

Then, the cylindrical hollow portion that extends from the element section 111 to the stage section 115 may be provided in the leg section 113.

Moreover, in the case where two dipole antennas 110 are paired for dual polarization, the stage section 115 may be used in common. By configuring as a single piece, it is possible to produce the dipole antennas 110 in bulk, and provide excellent mass production ability.

However, the two dipole antennas 110 shown in FIGS. 3A and 3B are paired to be combined, the conductors 116 are brought into contact with each other.

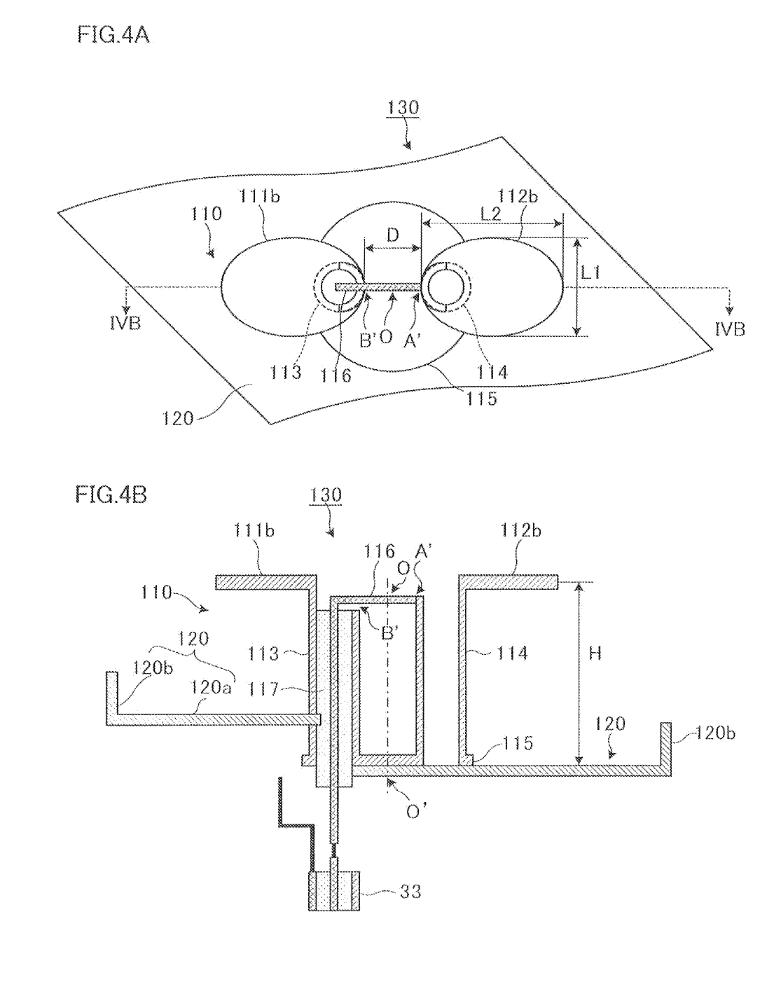

FIGS. 4A and 4B are diagrams illustrating a configuration of the dipole antenna 110, which is paired with the dipole antenna 110 in FIGS. 3A and 3B for dual polarization, in the first exemplary embodiment. FIG. 4A is a plan view, and FIG. 4B is a cross-sectional view at the IVB-IVB line in FIG. 4A.

FIGS. 4A and 4B show the dipole antenna 110 including the element sections 111b and 112b when the dipole antenna 110 in FIGS. 3A and 3B is assumed to include the element sections 111a and 112a (refer to FIG. 2). Accordingly, description will be given of the different portions, whereas description of the similar portions will be omitted.

In the dipole antenna 110 in FIGS. 4A and 4B, to prevent the conductor 116 of the dipole antenna 110 shown in FIGS. 4A and 4B from contacting the conductor 116 of the dipole antenna 110 in FIGS. 3A and 3B, portions indicated by arrows A′ and B′ on the point O side are cut down deeper toward the reflector 120 as compared to the case of the dipole antenna 110 in FIGS. 3A and 3B. This causes the conductors 116 of the pair of dipole antennas 110 to intersect on spatially different levels, to thereby prevent the conductors 116 from contacting each other.

Note that, in the dipole antenna 110, the element section 112b and the conductor 116 are connected at the portion indicated by arrow A′. The connection is conducted by soldering, for example.

As described above, in FIGS. 3A and 3B, the dipole antenna 110 does not necessarily include the stage section 115. In this case, the leg sections 113 and 114 may be extended by the length corresponding to the thickness of the stage section 115. Then, the leg sections 113 and 114 may be fixed to the front reflection section 120a of the reflector 120.

Note that, in the case where the stage section 115 is provided, since the dipole antenna 110 and the reflector 120 are able to be fixed by fixing the stage section 115 and the reflector 120 by screws or the like, assembly of the array antenna 10 is made easy.

So far, description has been given on the assumption that the surfaces of the element sections 111 and 112 are parallel to the front reflection section 120a of the reflector 120. However, the surfaces of the element sections 111 and 112 may not necessarily be parallel to the front reflection section 120a of the reflector 120. For example, the side of the element sections 111 and 112 closer to the point O may be approaching the front reflection section 120a of the reflector 120 than the side of the element sections 111 and 112 farther from the point O. To the contrary, the closer side may be away from the front reflection section 120a of the reflector 120. In other words, as shown in FIGS. 3A and 3B, the element section 111 and the element section 112 may be symmetric with respect to an axis OO′ that connects the point O and a point O′, which is vertical projection of the point O onto the front reflection section 120a of the reflector 120.

Further, the axis OO′ may not necessarily be vertical to the front reflection section 120a of the reflector 120, but may be inclined.

<Method of Feeding to Array Antenna 10>

Here, a supply method of the transmission signal (feeding method) in the array antenna 10 will be described.

FIG. 5 is a diagram illustrating an example of the method of feeding to the antenna 130 in the array antenna 10.

FIG. 5 shows the method of feeding to the odd-numbered dipole antennas 110 in the array antenna 10 shown in FIG. 2. In other words, it is assumed that the array antenna 10 shown in FIG. 5 includes only the odd-numbered dipole antennas 110 and does not include the even-numbered dipole antennas 110.

Consequently, similar to FIG. 2, it is assumed that there are 4 odd-numbered dipole antennas 110 (the dipole antennas 110-1, 110-3, 110-5 and 110-7) in FIG. 5, too. The antennas 130 corresponding to the dipole antennas 110-1, 110-3, 110-5 and 110-7 are represented as the antenna 130-1, 130-3, 130-5 and 130-7, respectively.

Note that, in the antenna 130 for dual polarization configured by pairing the odd-numbered dipole antenna 110 with the even-numbered dipole antenna 110, similar to the odd-numbered dipole antenna 110, the even-numbered dipole antenna 110 is also fed.

The phase shifter 200 includes three input and output ports (Port 0, Port 1 and Port 2) for the array antenna 10 constituted by the odd-numbered antennas 130 (antennas 130-1, 130-3, 130-5 and 130-7).

The Port 0 is connected to the transceiver unit 4. When the array antenna 10 radiates the radio frequency, the transceiver unit 4 feeds the Port 0 with the transmission signal. The phase shifter 200 outputs the transmission signal, which has been inputted into the Port 0, from the Port 1 and the Port 2 while shifting the phase thereof.

To the Port 1, one end of the main cable 32, as an example of the first feeding line, is connected. Then, to the other end of the main cable 32, as if the main cable 32 is to be divided, one ends of the respective secondary cables 33-1 and 33-2, as an example of two second feeding lines, are connected in parallel. The other end of the secondary cable 33-1 is connected to the antenna 130-1, whereas the other end of the secondary cable 33-2 is connected to the antenna 130-3.

For example, if it is assumed that the main cable 32 and the secondary cables 33-1 and 33-2 are coaxial cables, the inner conductor of the main cable 32 is connected to the inner conductor of each of the secondary cables 33-1 and 33-2, and the outer conductor of the main cable 32 is connected to the outer conductor of each of the secondary cables 33-1 and 33-2. Note that the two secondary cables 33-1 and 33-2 are collectively represented as a secondary cable 33, when not being distinguished from each other.

Accordingly, as has been described in FIGS. 3A and 3B, the other end portion of the conductor 116 of the antenna 130 is connected to the internal conductor of the secondary cable 33, and the reflector 120 is connected to the outer conductor of the secondary cable 33.

The same is true for the Port 2, and thereby description thereof will be omitted.

As described above, the antennas 130-1 and 130-3 are connected to the Port 1 of the phase shifter 200, and the transmission signals of the same phase are fed thereto. Similarly, since the antennas 130-5 and 130-7 are connected to the Port 2 of the phase shifter 200, the transmission signals of the same phase are also fed thereto.

However, the phase shifter 200 outputs the transmission signal, which has been inputted into the Port 0, from the Port 1 and the Port 2 while shifting the phase thereof. For example, if a phase shift amount, which is deviation in phase, is φ (°), it is possible to calculate the beam tilt angle θ shown in FIG. 1A (sin θ=(φ×λ) (2×Dp×360)) from the distance Dp in arrangement of the antennas 130 shown in FIG. 2 (here, since two antennas 130 are paired, 2×Dp). Note that, here, λ is a wavelength of the radio frequency which the antenna 130 radiates in a free space.

In FIG. 5, the antennas 130-1 and 130-3 were paired, and the transmission signals of the same phase were fed thereto in parallel. Similarly, the antennas 130-5 and 130-7 were paired, and the transmission signals of the same phase, which is different from the phase of the transmission signals fed to the pair of antennas 130-1 and 130-3, were fed thereto in parallel.

Each antenna 130 may be fed with a transmission signals having different phases. This makes it possible to reduce disturbances in directivity, although the radiating angle (beam tilt angle θ) is changed. However, the phase shifter 200 having the input and output ports corresponding to the number of antennas 130 constituting the array antenna 10 is required.

Accordingly, the plural antennas 130 are formed into some sets, and the transmission signals having the same phase are fed in parallel to the antennas 130 belonging to the same set.

Note that, in the case where the plural antennas 130 are formed into a set and the transmission signals are fed in parallel thereto, impedance matching is required. If the impedance matching is not achieved, return loss of the antenna 130 is increased.

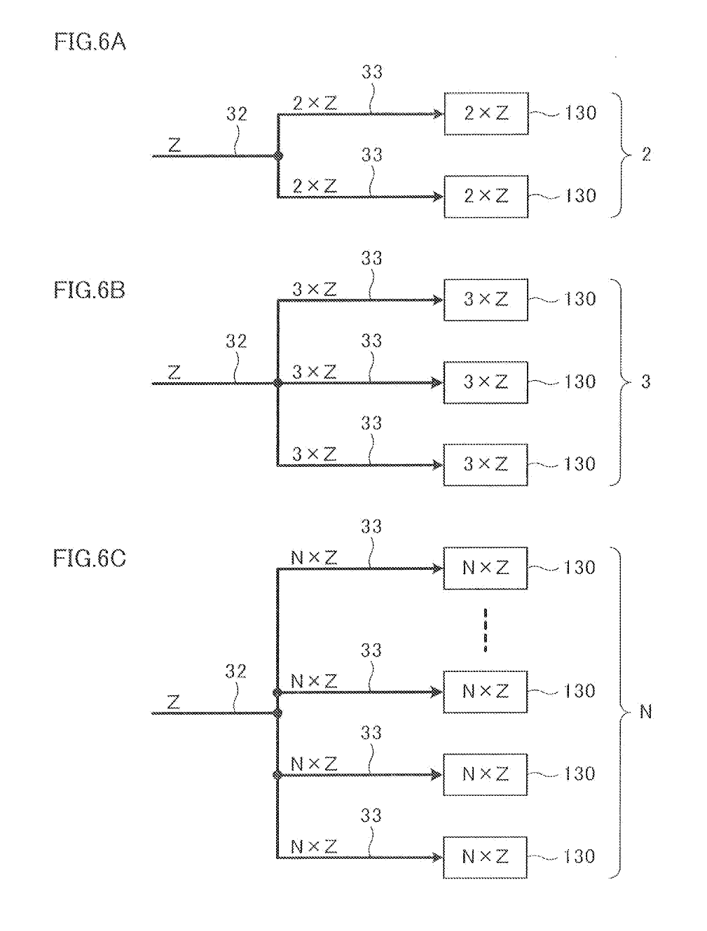

FIGS. 6A to 6c are diagrams illustrating relation among impedances of the main cable 32 and the secondary cables 33 and input impedances of the antennas 130 in the case where the first exemplary embodiment is applied. In FIGS. 6A to 6C, the plural antennas 130 and the plural secondary cables 33 are illustrated, but without being distinguishing from one another, represented as the antennas 130 and the secondary cables 33.

Moreover, the impedance of each of the main cable 32 and the secondary cables 33 and the input impedance of the antenna 130 are illustrated.

Here, it is assumed that the impedance of the main cable 32 from the phase shifter 200 shown in FIG. 5 is Z (an example of a first impedance). Then, it is assumed that the impedance matching is achieved from the transceiver unit 4 to the main cable 32 of the phase shifter 200.

Similar to FIG. 5, FIG. 6A shows the case in which the two antennas 130 are paired and the transmission signals having the same phase are fed in parallel thereto. The input impedance of the antenna 130 is set to 2×Z.

Since the impedance of the main cable 32 is Z, by dividing thereof into two, the impedances of the secondary cables 33 become 2×Z.

The input impedance of the antenna 130 is also 2×Z, and accordingly, impedance matching is achieved.

In other words, as shown in FIG. 5, impedance matching is achieved by dividing the main cable 32 into a pair of secondary cables 33 and connecting each of the secondary cables 33 directly to the antenna 130.

Unlike in the case of FIG. 5, FIG. 6B shows a case in which the three antennas 130 are formed into a set and the transmission signals having the same phase are fed in parallel thereto. The input impedance of the antenna 130 is set to 3×Z. Since the impedance of the main cable 32 is Z, by dividing thereof into three, the impedances of the secondary cables 33 become 3×Z.

The input impedance of the antenna 130 is also 3×Z, and accordingly, impedance matching is achieved.

In other words, impedance matching is achieved by dividing the main cable 32 into three secondary cables 33 and connecting each of the secondary cables 33 to the antenna 130.

Unlike in the case of FIG. 5, FIG. 6C shows a case in which the N (N is an integer not less than 2) antennas 130 are formed into a set and the transmission signals having the same phase are fed in parallel thereto. The input impedance of the antenna 130 is set to N×Z (an example of a second impedance). Since the impedance of the main cable 32 is Z, by dividing thereof into N, the impedances of the secondary cables 33 become N×Z.

The input impedance of the antenna 130 is also N×Z, and accordingly, impedance matching is achieved.

In other words, impedance matching is achieved by dividing the main cable 32 into N secondary cables 33 and connecting each of the secondary cables 33 to the antenna 130.

Note that, in the above description, it was assumed that the impedance of the antenna 130 was set to 2×Z, 3×Z and N×Z with respect to the impedance Z of the main cable 32; however, the impedance of the antenna 130 may be values shifted around these values set based thereon.

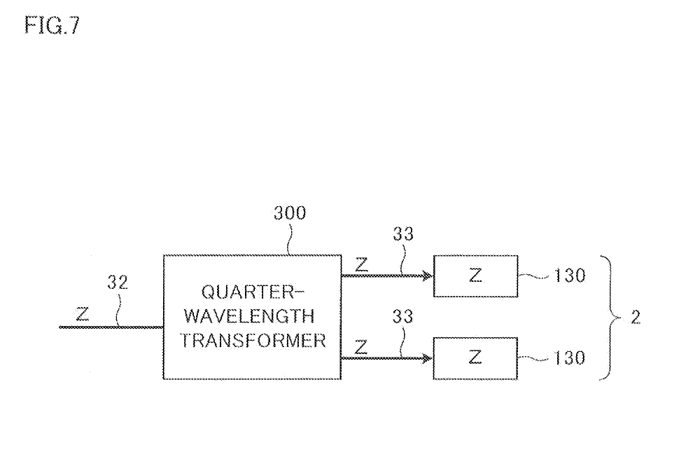

FIG. 7 is a diagram illustrating relation among impedances of the main cable 32 and the secondary cables 33 and input impedances of the antennas 130 in the case where the first exemplary embodiment is not applied. Even in the case, the two antennas 130 are paired and the transmission signals having the same phase are fed in parallel thereto. It is assumed that the input impedance of the antenna 130 is Z at this time. If the main cable 32 is divided into two, it is required to set the impedance of the secondary cable 33 to 2×Z, as described above. For this reason, impedance matching cannot be achieved by connecting the secondary cables 33 each having the impedance of 2×Z to the antennas 130 each having the impedance of Z. Accordingly, it is necessary to set the impedance of the secondary cable 33 to Z by providing a quarter-wavelength transformer 300 configured with a microstrip line or the like between the main cable 32 and the antennas 130.

The quarter-wavelength transformer 300 constituted by the microstrip line or the like is configured to resonate with the wavelength λc of the center frequency fc of the radio wave radiated from the antenna 130. Consequently, the quarter-wavelength transformer 300 has frequency dependence, and accordingly, has difficulty in adapting to wide-band frequency. Moreover, though the quarter-wavelength transformer 300 can be provided in a multistage configuration to widen the range of adaptable frequency, the quarter-wavelength transformer 300 still has characteristics dependent on frequency even in this case.

Accordingly, even though the antenna 130 has wide-band frequency characteristics, the range of frequency that can be used is limited by the frequency characteristics of the quarter-wavelength transformer 300.

In contrast to this, in the first exemplary embodiment, since the input impedance of the antenna 130 is set corresponding to the impedance of the secondary cable 33, the secondary cables 33 and the antennas 130 are able to be directly connected. For this reason, it is possible to transmit and receive the radio frequency in the frequency range of the wide-band antenna 130.

Note that, in the above description, the main cable 32 and the secondary cable 33 were explained as the coaxial cables; however, the cables may be configured by other system, such as the microstrip line.

### <Characteristics of Antenna 130>

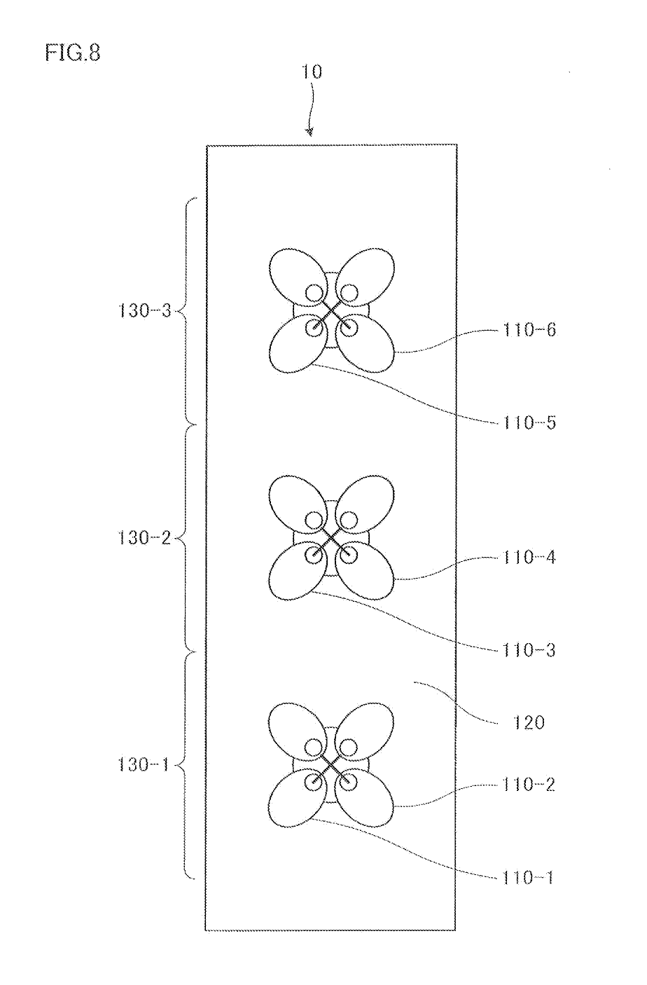

FIG. 8 is a diagram illustrating a model used for performing simulation of characteristics of the antenna 130. Six dipole antennas 110-1 to 110-6 are used, and the odd-numbered ones and the even-numbered ones are respectively paired for dual polarization. Note that the odd-numbered dipole antenna 110 is combined with the even-numbered dipole antenna 110, to thereby configure the antenna 130. Here, the dipole antenna 110-1 and the dipole antenna 110-2 configure the dual polarized antenna 130-1, the dipole antenna 110-3 and the dipole antenna 110-4 configure the dual polarized antenna 130-2, and the dipole antenna 110-5 and the dipole antenna 110-6 configure the dual polarized antenna 130-3.

The transmission signal for transmitting the radio frequency was fed to the dipole antenna 110-3 of the dual polarized antenna 130-2. The transmission signals were not fed to the other antennas 130-1 and 130-3, and the dipole antenna 110-4 of the antenna 130-2 to use as dummy antennas.

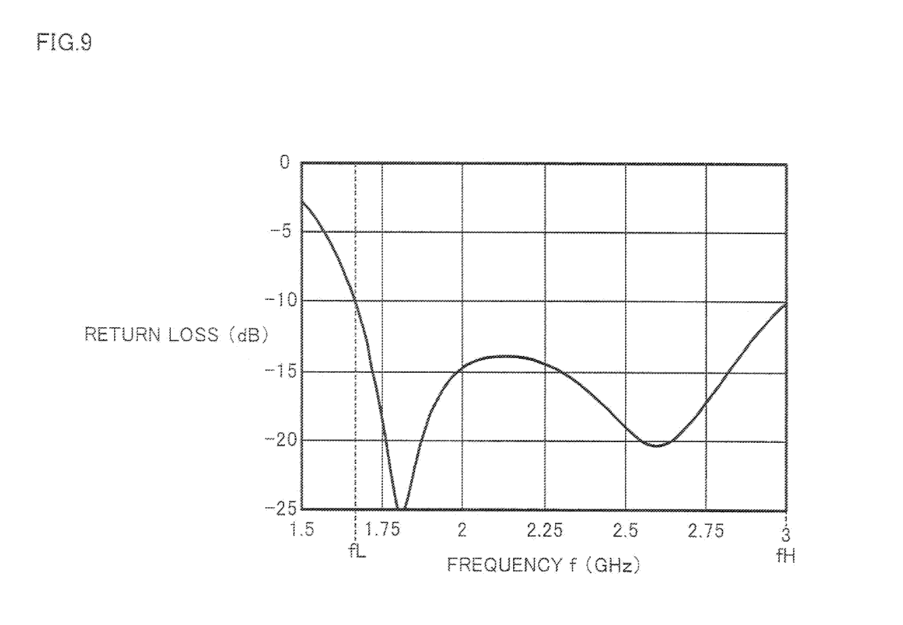

FIG. 9 is a diagram showing return loss (dB) characteristics of the antenna 130 in the first exemplary embodiment, which is obtained by the simulation model shown in FIG. 8. In the dipole antenna 110 of the antenna 130, the minor axis L1 of the element sections 111 and 112 is 21 mm, the major axis L2 thereof is 30 mm, and the distance D between the element sections 111 and 112 is 12 mm. The height H from the center in the thickness direction of the element sections 111 and 112 to the reflector 120 is 38.5 mm.

In the frequency range in which the return loss is not more than −10 dB (VSWR≦2), the lower limit frequency fL is 1.6 GHz and the upper limit frequency fH is 3 GHz. The relative bandwidth is 61%.

In the antenna using the dipole antenna including the rod-shaped element sections 111 and 112, the relative bandwidth is about 25%. Even though this dipole antenna is wide-banded by adding parasitic elements, the relative bandwidth thereof is about 40%.

Accordingly, the antenna 130 of the first exemplary embodiment is further wide-banded as compared to the antenna using the dipole antenna 110 including the rod-shaped element sections 111 and 112 added with the parasitic elements.

Moreover, the antenna 130 of the first exemplary embodiment has less components and is easy to be produced as compared to the antenna using the dipole antenna 110 having complex configuration added with the parasitic elements.

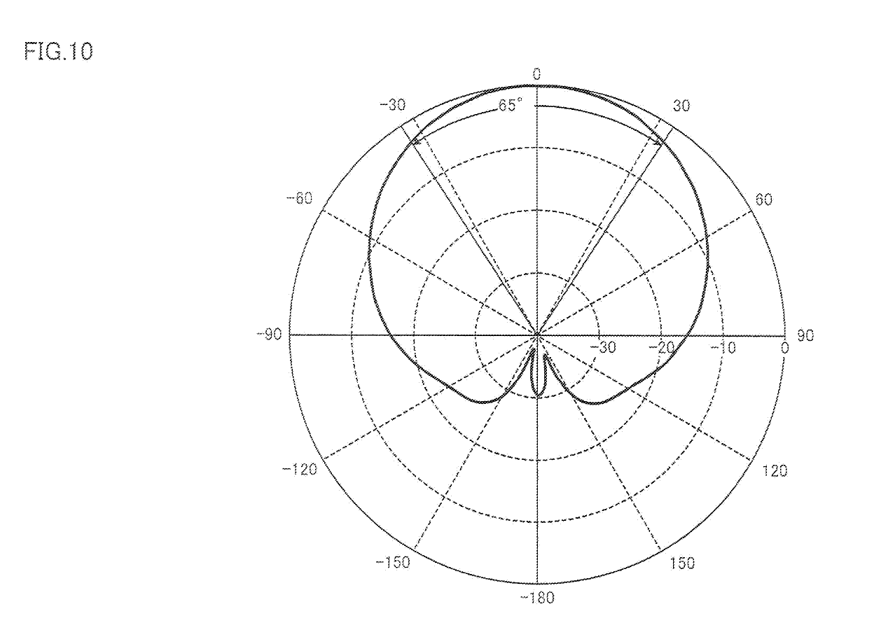

FIG. 10 is a diagram showing a horizontal-plane beam width of the antenna 130 in the first exemplary embodiment, which is obtained by the simulation model shown in FIG. 8. Here, the figure shows the case in which the frequency f is 2 GHz. As the horizontal-plane beam width in the antenna 130, 65° is obtained.

As described above, the horizontal-plane bean width is able to be defined by the side reflection section 120b. Consequently, by adjusting the width of the reflector 120, the shape of the side reflection section 120b, the number thereof or the like, it is possible to adjust the horizontal-plane beam width of the antenna 130.

Table 1 shows the input impedance (Ω) of the antenna 130 in the case where the minor axis L1 of the element sections 111 and 112 shown in FIGS. 3A and 3B is changed, which is a result obtained by simulation.

In the simulation, the impedance of the secondary cable 33, which serves as the feeding line to the antenna 130, was changed and the impedance of a portion constituted by the conductor 116 and the insulator 117 provided in the hollow part of the leg section 113 shown in FIGS. 3A and 3B was also changed, to thereby set the impedance in which the relative bandwidth of the return loss not more than −10 dB became widest as the input impedance of the antenna 130. In other words, the setting is made so that impedance matching is achieved in the route from the secondary cable 33, which serves as the feeding line, to the element sections 111 and 112 of the dipole antenna 110.

Here, the major axis L2 is 30 mm, the distance D between the element sections 111 and 112 is 12 mm, and the height H from the center in the thickness direction of the element sections 111 and 112 to the reflector 120 is 38.5 mm.

TABLE 1

| L1 (mm) | Input impedance of antenna (Ω) |
|---|---|
| 21 | 100 |
| 18 | 150 |
| 15 | 175 |

As shown in Table 1, the larger the minor axis L1 of the element sections 111 and 112 of the dipole antenna 110, the smaller the input impedance of the antenna 130, and, for example, the input impedance is 1000 with the minor axis L1 of 21 mm. To the contrary, the smaller the minor axis L1, the larger the input impedance, and, for example, the input impedance is 1750 with the minor axis L1 of 15 mm.

In other words, in the first exemplary embodiment, it is possible to set the input impedance of the antenna 130 by the minor axis L1 of the element sections 111 and 112 of the dipole antenna 110.

Note that the result shown in Table 1 is merely an example, and the input impedance of the antenna 130 can further be changed by further changing the minor axis L1 of the element sections 111 and 112 of the dipole antenna 110.

Therefore, in the case where the main cable 32 shown in FIG. 6A is divided into a pair of secondary cables 33 to be connected to a pair of antennas 130, assuming that the impedance Z of the main cable 32 is 500, the impedance of the secondary cables 33 becomes 2×Z, namely, 1000. Accordingly, the antenna 130 in which the minor axis L1 of the dipole antenna 110 is set to 21 mm may be used so that the input impedance thereof becomes 1000.

Moreover, in the case where the main cable 32 shown in FIG. 6B is divided into three secondary cables 33 to be connected to three antennas 130, assuming that the impedance Z of the main cable 32 is 500, the impedance of the secondary cables 33 becomes 3×Z, namely, 150Ω. Accordingly, the antenna 130 in which the minor axis L1 of the dipole antenna 110 is set to 18 mm may be used so that the input impedance thereof becomes 1500.

In the antenna using the dipole antenna including the rod-shaped element sections 111 and 112, unlike the antenna 130 of the first exemplary embodiment, the input impedance cannot be changed though the width of the rod is changed.

Table 2 shows the input impedance (Ω) of the antenna 130 in the case where the height H from the center in the thickness direction of the element sections 111 and 112 shown in FIGS. 3A and 3B to the reflector 120 is changed, which is a result obtained by simulation.

In this simulation, also, the impedance of the transmission and reception cable 31, which serves as the feeding line to the antenna 130, was changed and the impedance of a portion constituted by the conductor 116 and the insulator 117 provided in the hollow part of the leg section 113 shown in FIGS. 3A and 3B was also changed, to thereby set the impedance in which the relative bandwidth of the return loss not more than −10 dB became widest as the input impedance of the antenna 130. In other words, the setting is made so that impedance matching is achieved in the route from the feeding line to the element sections 111 and 112 of the dipole antenna 110.

Here, the minor axis L1 is 21 mm, the major axis L2 is 30 mm, and the distance D between the element sections 111 and 112 is 12 mm.

TABLE 2

| H (mm) | Input impedance of antenna (Ω) |
|---|---|
| 32.5 | 150 |
| 35 | 125 |
| 37.5 | 100 |
| 40 | 87 |
| 42.5 | 75 |

As shown in Table 2, the smaller the height H from the center in the thickness direction of the element sections 111 and 112 of the dipole antenna 110 to the reflector 120, the larger the input impedance of the antenna 130, and, for example, the input impedance is 1500 with the height H of 32.5 mm. To the contrary, the smaller the height H, the larger the input impedance, and, for example, the input impedance is 750 with the height H of 42.5 mm.

In other words, in the first exemplary embodiment, it is also possible to set the input impedance of the antenna 130 by changing the height H from the center in the thickness direction of the element sections 111 and 112 of the dipole antenna 110 to the reflector 120.

Note that the result shown in Table 2 is merely an example, and the input impedance of the antenna 130 can further be changed by further changing the height H from the center in the thickness direction of the element sections 111 and 112 of the dipole antenna 110 to the reflector 120.

Therefore, in the case where the main cable 32 shown in FIG. 6A is divided into a pair of secondary cables 33 to be connected to a pair of antennas 130, assuming that the impedance Z of the main cable 32 is 50Ω, the impedance of the secondary cables 33 becomes 2×Z, namely, 100Ω. Accordingly, the antenna 130 in which the height H of the dipole antenna 110 is set to 37.5 mm may be used so that the input impedance thereof becomes 100Ω.

Moreover, in the case where the main cable 32 shown in FIG. 6B is divided into three secondary cables 33 to be connected to three antennas 130, assuming that the impedance Z of the main cable 32 is 50Ω, the impedance of the secondary cables 33 becomes 3×Z, namely, 150Ω. Accordingly, the antenna 130 in which the height H of the dipole antenna 110 is set to 32.5 mm may be used so that the input impedance thereof becomes 150Ω.

As described above, in the antenna 130 to which the first exemplary embodiment is applied, it is possible to set the input impedance of the antenna 130 by changing parameters for establishing the shape of the dipole antenna 110, such as the minor axis L1 of the element sections 111 and 112, and the height H from the center in the thickness direction of the element sections 111 and 112 of the dipole antenna 110 to the reflector 120 in the antenna 130.

Accordingly, in the case where the impedance of the main cable 32 is Z and the main cable 32 is divided into the N secondary cables 33, the shape of the antenna 130 may be established to set the input impedance of the antenna 130 to N×Z.

Moreover, as shown in FIG. 9, the antenna 130 of the first exemplary embodiment shows two resonance frequencies. The resonance frequency on the lower frequency side exists in the vicinity of 1.8 GHz and the resonance frequency on the higher frequency side exists in the vicinity of 2.6 GHz.

Then, from the data of changing the shape of the element sections 111 and 112, it was learned that the resonance frequency on the lower frequency side tends to depend on the length of the outer edge of the element sections 111 and 112 of the dipole antenna 110, and the resonance frequency on the higher frequency side tends to depend on the minor axis L1 of the element sections 111 and 112 of the dipole antenna 110.

Therefore, by changing the length of the outer edge (perimeter) and the minor axis L1 of the element sections 111 and 112, it is possible to set the frequency range in which the return loss is not more than a predetermined value.

Further, by setting the same length of the outer edge (perimeter) and the same minor axis L1 of the element sections 111 and 112, it is possible to provide the antenna 130 using the dipole antenna 110 in which the frequency range not more than the return loss is set in a similar manner.

### Second Exemplary Embodiment

In the first exemplary embodiment, the shape of the element sections 111 and 112 of the dipole antenna 110 in the antenna 130 was the ellipse. In the second exemplary embodiment, the shape of the element sections 111 and 112 of the dipole antenna 110 in the antenna 130 was made by connecting a pentagon to a semi-ellipse.

The configurations of other components are similar to the first exemplary embodiment, and thereby description of the similar components will be omitted and the configuration of the dipole antenna 110, which is the different component, will be described.

### <Configuration of Dipole Antenna 110>

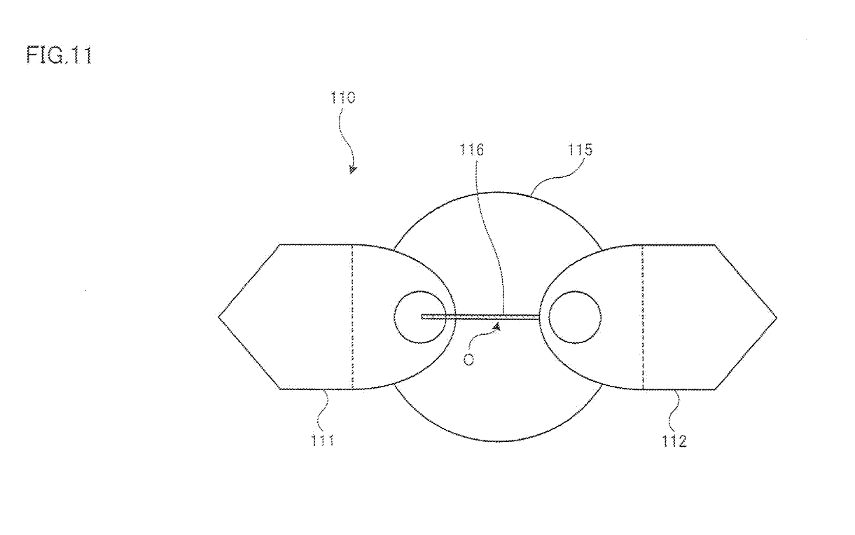

FIG. 11 is a plan view illustrating the configuration of the dipole antenna 110 in the second exemplary embodiment.

In the dipole antenna 110 in FIG. 11, the outer edge of the element sections 111 and 112 is elliptic at a portion closer to the point O (the boundary is indicated by broken lines), and at a portion away from the point O, the outer edge is pentagonal in which one of the vertexes protrudes in a direction away from the point O.

Even though the dipole antenna 110 has such a shape, the antenna 130 has wide-band frequency characteristics, and it is also possible to set the input impedance of the antenna 130 by changing the parameters for establishing the shape of the dipole antenna 110.

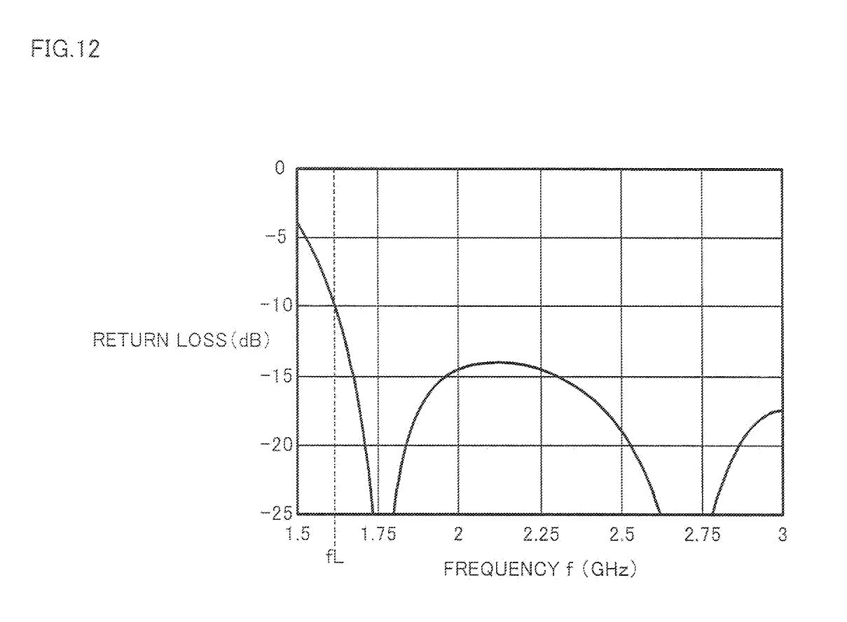

FIG. 12 is a diagram showing the return loss (dB) characteristics of the antenna 130 in the second exemplary embodiment. These characteristics were obtained, with respect to the antenna 130 configured by using the dipole antenna 110 shown in FIG. 11, by the simulation model shown in FIG. 8 of the first exemplary embodiment.

In the frequency range in which the return loss is not more than −10 dB (VSWR≦2), the lower limit frequency fL is 1.6 GHz and the upper limit frequency fH (not shown) is not less than 3 GHz. The antenna 130 has wider-band characteristics than the antenna 130 in the first exemplary embodiment.

### Third Exemplary Embodiment

In the third exemplary embodiment, similar to the second exemplary embodiment, the shape of the element sections 111 and 112 of the dipole antenna 110 in the antenna 130 of the first exemplary embodiment was changed.

The configurations of other components are similar to the first exemplary embodiment, and thereby description of the similar components will be omitted and the configuration of the dipole antenna 110, which is the different component, will be described.

### <Configuration of Dipole Antenna 110>

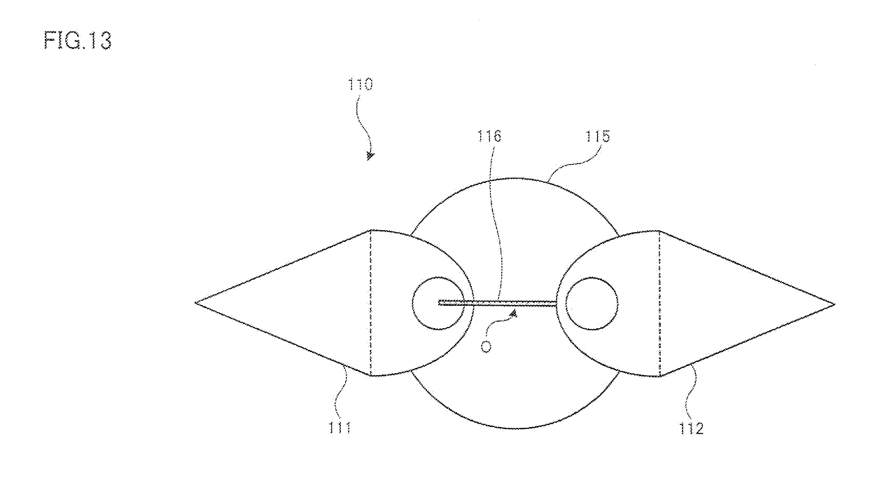

FIG. 13 is a plan view illustrating the configuration of the dipole antenna 110 in the third exemplary embodiment.

In the dipole antenna 110 in FIG. 13, the outer edge of the element sections 111 and 112 is elliptic at a portion closer to the point O (the boundary is indicated by broken lines), and at a portion away from the point O, the outer edge is triangular in which one of the vertexes protrudes in a direction away from the point O.

Even though the dipole antenna 110 has such a shape, the antenna 130 has wide-band frequency characteristics, and it is also possible to set the input impedance of the antenna 130 by changing the parameters for establishing the shape of the dipole antenna 110.

### Fourth Exemplary Embodiment

In the fourth exemplary embodiment, similar to the second and third exemplary embodiments, the shape of the element sections 111 and 112 of the dipole antenna 110 in the antenna 130 of the first exemplary embodiment was changed.

The configurations of other components are similar to the first exemplary embodiment, and thereby description of the similar components will be omitted and the configuration of the dipole antenna 110, which is the different component, will be described.

### <Configuration of Dipole Antenna 110>

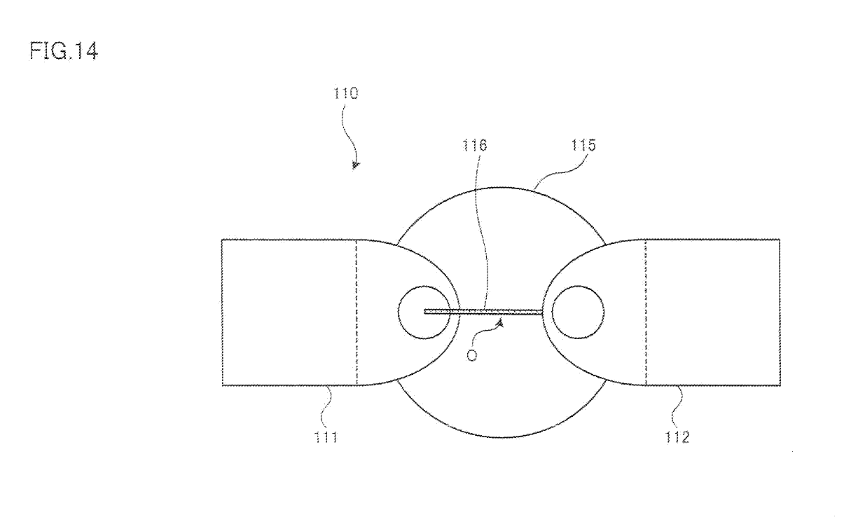

FIG. 14 is a plan view illustrating the configuration of the dipole antenna 110 in the fourth exemplary embodiment.

In the dipole antenna 110 in FIG. 14, the outer edge of the element sections 111 and 112 is elliptic at a portion closer to the point O (the boundary is indicated by broken lines), and at a portion away from the point O, the outer edge is rectangular that protrudes in a direction away from the point O.

Even though the dipole antenna 110 has such a shape, the antenna 130 has wide-band frequency characteristics, and it is also possible to set the input impedance of the antenna 130 by changing the parameters for establishing the shape of the dipole antenna 110.

As described in the first to fourth exemplary embodiments, the antenna 130 having a wide frequency range in which the return loss is not more than a predetermined value can be obtained by configuring the element sections 111 and 112 of the dipole antenna 110 with a conductive material and forming the outer edge thereof in a shape including a curved line, such as an ellipse.

Then, it is possible to set the input impedance of the antenna 130 by changing the parameters for establishing the shape of the above-described dipole antenna 110, such as the minor axis L1 of the element sections 111 and 112, the height H from the center in the thickness direction of the element sections 111 and 112 to the reflector 120, the major axis L2 of the element sections 111 and 112 and the distance D between the element sections 111 and 112 of the dipole antenna 110.

Moreover, by forming the portions in the vicinity of the point O in symmetrically arranging the element section 111 and the element section 112 of the dipole antenna 110 by curved lines such as the elliptical shape that is convex toward the point O, in the case where another dipole antenna 110, which transmits and receives the polarization orthogonal to the polarization of the radio frequency transmitted and received by this dipole antenna 110, is pared while sharing the point O for dual polarization, the two dipole antennas 110 having been paired can be easily combined without overlapping each other.

Further, by changing the length of the outer edge (perimeter) and the minor axis L1 of the element sections 111 and 112 of the dipole antenna 110, it is possible to set the frequency range in which the return loss is not more than a predetermined value. Consequently, it is possible to select the edge shape of the element sections 111 and 112 while setting the frequency range. This makes it easy, in the case where two dipole antennas 110 are paired for dual polarization, to establish the shape thereof not to overlap each other.

Note that, in the first to fourth exemplary embodiments, it was assumed that the element sections 111 and 112, the leg sections 113 and 114, and the stage section 115 were configured with a conductive material as a single piece or individually. However, the element sections 111 and 112 may be configured with metal foil or the like put on a dielectric substrate. In this case, the leg sections 113 and 114 are configured with metal rods or the like, and the element sections 111 and 112 configured with the metal foil or the like may be connected to the front reflection section 120a of the reflector 120. Then, the signal for transmitting the radio frequency to the element section 112 may be fed by the coaxial cable or the like.

### Fifth Exemplary Embodiment

The array antenna 10 in the first to fourth exemplary embodiments was configured by arranging the antennas 130 for dual polarization in one direction.

The array antenna 10 in the fifth exemplary embodiment is configured by arranging plural antennas 130 in line so that directions of electric fields coincide with one another. The array antenna 10 is an omnidirectional antenna that radiates vertical polarization in the directions of 360°.

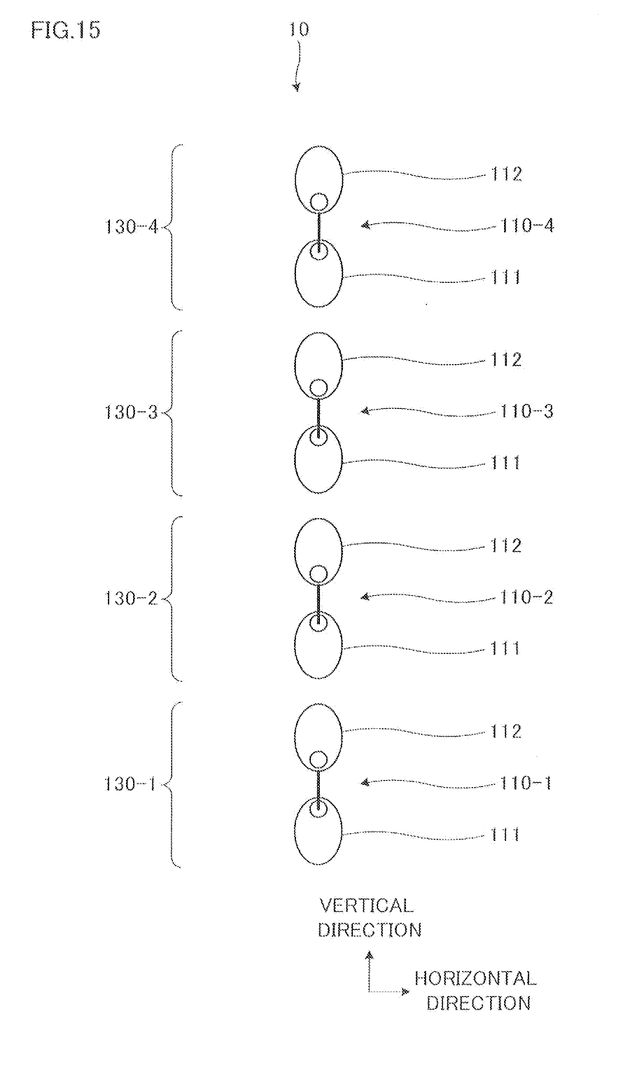

FIG. 15 is a diagram showing an example of a configuration of the array antenna 10 capable of radiating vertical polarization in the fifth exemplary embodiment. In FIG. 15, four antennas 130-1, 130-2, 130-3 and 130-4 are linearly (in the vertical direction) arranged. Note that each of the four antennas 130-1, 130-2, 130-3 and 130-4 has a configuration such that, in the antenna 130 shown in FIGS. 3A and 3B of the first exemplary embodiment, the dipole antenna 110 includes the element sections 111 and 112, but does not include the leg sections 113, 114 and the stage section 115. Moreover, each of the four antennas does not include the reflector 120. The conductor 116 is connected to the element section 112 via the opening of the element section 111 of the dipole antenna 110. Then, each of the four antennas is fed in the same direction so that the radiating electric field oscillates in the vertical direction.

This makes it possible to provide the array antenna 10 that radiates (transmits) the vertical polarization. Note that the array antenna 10 is able to receive the vertical polarization in which the electric fields oscillate in the vertical direction, owing to the reversibility of the antenna.

In the array antenna 10 in the fifth exemplary embodiment shown in FIG. 15, the antennas 130-1 and 130-2 can be paired to be fed. In other words, the main cable 32 and the secondary cables 33, which are the feeding lines, may be connected as shown in FIG. 6A. Note that the same may be true for the pair of antennas 130-3 and 130-4.

Moreover, it may be possible to form a set of antennas 130-1 to 130-4 and carry out connection as shown in FIG. 6C. In this case, N=4.

Here, the array antenna 10 was configured with four antennas 130; however, the number of antennas 130 is not limited to four and the number may be two, three, or may be more than four. In these cases, it may be possible to divide the plural antennas 130 into plural sets, provide the main cable 33 to each set and provide the secondary cables 33 branching off therefrom, to thereby carry out feeding. Note that the whole may be regarded as one set, without being divided into the plural sets.

Further, in the case of being divided into the plural sets, by feeding the transmission signals having different phases to each set, the radiating angle (beam tilt angle θ) of the radio frequency can be tilted from the horizontal plane toward the ground direction or the like.

As described in the first exemplary embodiment, the input impedance of the antenna 130 can be set by changing the parameter for establishing the shape of the dipole antenna 110. Therefore, similar to the first exemplary embodiment, by setting the input impedance of the antenna 130 corresponding to the impedance of the secondary cable 33 and directly connecting the main cable 32 and the secondary cables 33 branching off therefrom, impedance matching is achieved. For this reason, it is possible to transmit and receive the radio frequency in the frequency range of the wide-band antenna 130.

Note that the array antenna 10 here included the antennas 130 arranged in the vertical direction, but the antennas 130 may be arranged in the horizontal direction or in a direction tilted from the vertical direction. In this case, the polarization oscillating in the horizontal direction or the tilted direction are radiated.

### Sixth Exemplary Embodiment

The array antenna 10 in the fifth exemplary embodiment was the omnidirectional antenna that radiated the vertical polarization.

The array antenna 10 in the sixth exemplary embodiment is the omnidirectional antenna that radiates horizontal polarization in the directions of 360°.

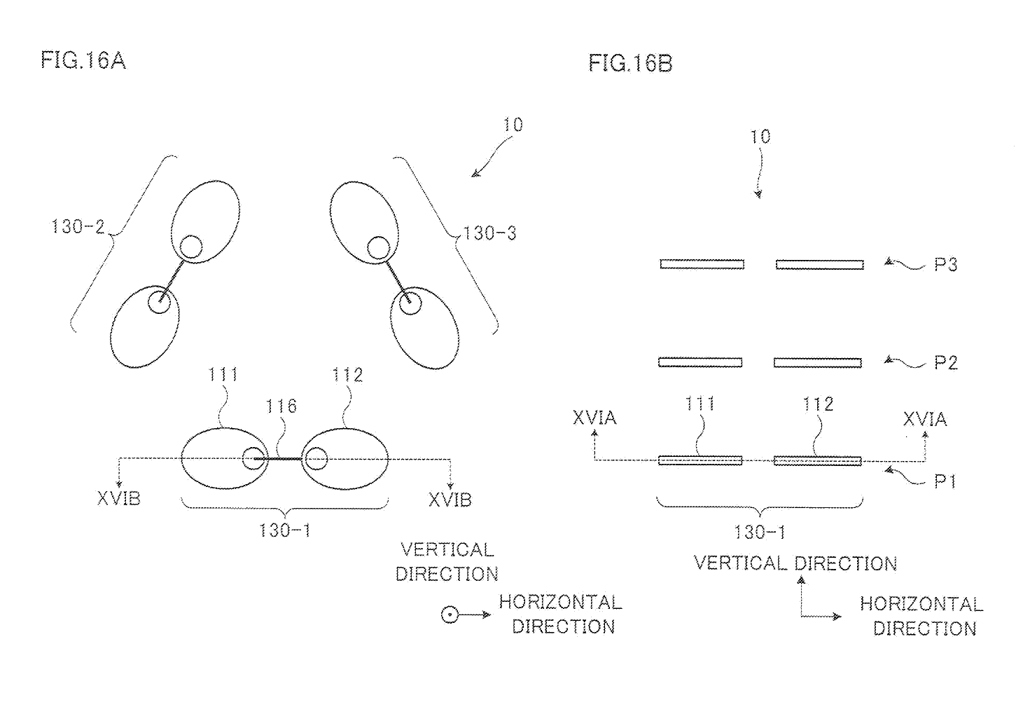

FIGS. 16A and 16B are diagrams showing an example of a configuration of the array antenna 10 capable of radiating the horizontal-polarization in the sixth exemplary embodiment. FIG. 16A is a plan view of the array antenna 10, and FIG. 16B is a cross-sectional view of the array antenna 10 at the XVIB-XVIB line in FIG. 16A. Note that the plan view in FIG. 16A is a plan view of the array antenna 10 at the XVIA-XVIA line in FIG. 16B.

As shown in FIG. 16B, the array antenna 10 of the sixth exemplary embodiment is configured with, for example, three layers (layers P1 to P3) overlapped in the vertical direction. When the layers P1 to P3 are not distinguished from one another, each of the layers is represented as a layer P. As shown in FIG. 16A, each layer P is configured with three antennas 130 (antennas 130-1, 130-2 and 130-3) on a horizontal plane. Note that each of the three antennas 130-1, 130-2 and 130-3 has a configuration such that, in the antenna 130 shown in FIGS. 3A and 3B of the first exemplary embodiment, the dipole antenna 110 includes the element sections 111 and 112, but does not include the leg sections 113, 114 and the stage section 115. Moreover, each of the three antennas does not include the reflector 120. The conductor 116 is connected to the element section 112 via the opening of the element section 111.

The antennas 130-1, 130-2 and 130-3 are arranged on sides of a triangle so that the lines connecting the element sections 111 and the element sections 112 of the dipole antennas 110 mutually cross at the angle of 60°.

Then, as shown in FIG. 16B, these antennas 130-1, 130-2 and 130-3 are overlapped in plural layers.

This makes it possible to provide the array antenna 10 that transmits and receives the horizontal polarization in which the electric fields oscillate in a horizontal plane. Note that the array antenna 10 is able to receive the horizontally-polarized waves polarization in which the electric fields oscillate in the horizontal direction, owing to the reversibility of the antenna.

Note that, in the array antenna 10 here, the antennas 130 in each layer P are arranged on the horizontal plane; however, the antennas 130 may be arranged on a plane tilted from the horizontal plane. In this case, the polarization oscillating in the direction of the tilted plane are radiated.

In the array antenna 10 in the sixth exemplary embodiment shown in FIGS. 16A and 16B, the antennas 130-1, 130-2 and 130-3 constituting the layer P1 can be formed into a set to carry out feeding. In other words, the main cable 32 and the secondary cables 33, which are the feeding lines, may be connected as shown in FIG. 6B. Note that the same may be for the sets of antennas 130 in the other layers P2 and P3.

Moreover, it may be possible to form a set of antennas 130-1 in the respective layers P1 to P3, and carry out connection as shown in FIG. 6B. The same may be for the other sets of antennas 130-2 and 130-3.

Further, it may be possible to form a set of all of the antennas 130-1, 130-2 and 130-3 in the respective layers P1 to P3, and carry out connection as shown in FIG. 6C. In this case, N=9.

Moreover, the sets may be configured by other combinations.

Here, the array antenna 10 in each of the layers P1 to P3 was configured with three antennas 130; however, the number of antennas 130 is not limited to three, and the number may be two, or more than three. However, in the case of two, as shown in FIG. 2, it is necessary to arrange the two antennas 130 at the positions rotated 90°, and carry out feeding with phase difference of 90° from each other.

In these cases, it may be possible to divide the plural antennas 130 into plural sets, provide the main cable 33 to each set and provide the secondary cables 33 branching off therefrom, to thereby carry out feeding. Note that the whole may be regarded as one set, without being divided into the plural sets.

Further, in the case of being divided into the plural sets, by supplying the transmission signals having different phases to each set, the radiating angle (beam tilt angle θ) of the radio frequency can be tilted from the horizontal plane toward the ground direction.

As described in the first exemplary embodiment, the input impedance of the antenna 130 can be set by changing the parameter for establishing the shape of the dipole antenna 110. Therefore, similar to the first exemplary embodiment, by setting the input impedance of the antenna 130 corresponding to the impedance of the secondary cable 33 and directly connecting the main cable 32 and the secondary cables 33 branching off therefrom, impedance matching is achieved. For this reason, it is possible to transmit and receive the radio frequency in the frequency range of the wide-band antenna 130.

Further, it is possible to provide a dual polarized omnidirectional antenna by combining the array antenna 10 in the fifth exemplary embodiment and the array antenna 10 in the sixth exemplary embodiment.

The combination of the array antenna 10 in the fifth exemplary embodiment and the array antenna 10 in the sixth exemplary embodiment can be achieved by, for example, inserting the antennas 130 of the array antenna 10 in the sixth exemplary embodiment between the respective antennas 130 of the array antenna 10 in the fifth exemplary embodiment.

### Seventh Exemplary Embodiment

The array antenna 10 in the fifth exemplary embodiment was the omnidirectional antenna that transmitted and received the vertical polarization, and the array antenna 10 in the sixth exemplary embodiment was the omnidirectional antenna that transmitted and received the horizontal polarization.

The array antenna 10 in the seventh exemplary embodiment is an array antenna 10 that transmits and receives the radio frequency bi-directionally in the horizontal direction.

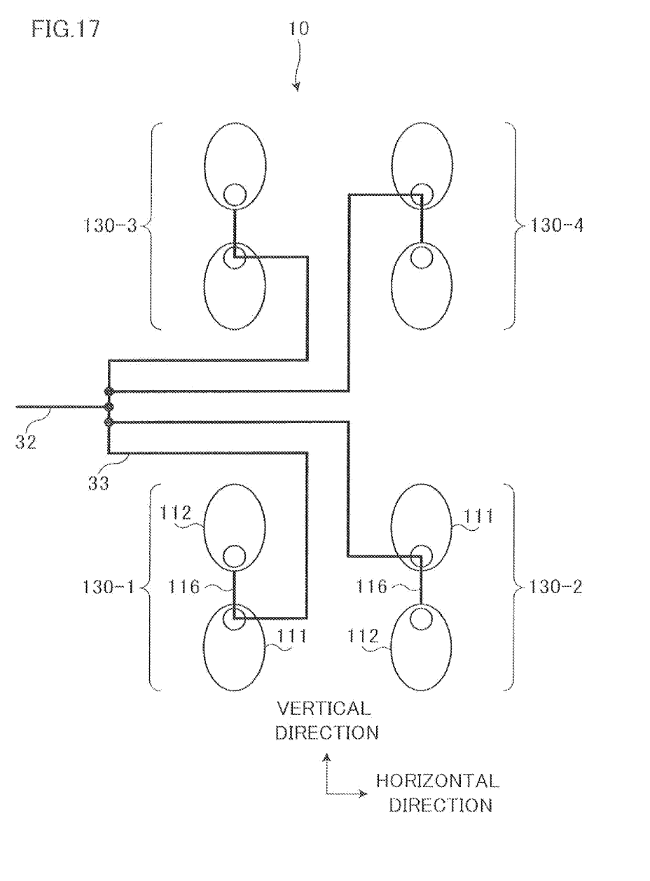

FIG. 17 is a diagram showing an example of a configuration of the array antenna 10 capable of radiating bi-directionally in the seventh exemplary embodiment.

As shown in FIG. 17, the array antenna 10 of the seventh exemplary embodiment is configured with, for example, four antennas 130. Of these, the two antennas 130-1 and 130-2 are arranged in the horizontal direction. In the same manner, the two antennas 130-3 and 130-4 are arranged in the horizontal direction. Then, the pair of antennas 130-1, 130-2 and the pair of antennas 130-3, 130-4 are arranged in the vertical direction.

Each of the four antennas 130-1, 130-2, 130-3 and 130-4 includes, in the antenna 130 shown in FIGS. 3A and 3B of the first exemplary embodiment, the element sections 111 and 112, but does not include the leg sections 113, 114, the stage section 115 and the reflector 120. The conductor 116 is connected to the element section 112 via the opening of the element section 111.

Then, the antenna 130 is arranged so that a straight line connecting the element section 111 and the element section 112 is in the vertical direction. However, in the pair of antennas 130-1 and 130-2, positions of the element sections 111 and 112 are reversed, to thereby reverse the feeding directions. The same is true for the pair of antennas 130-3 and 130-4. Note that the antennas 130-1 and 130-3 arranged in the vertical direction have the same positional relation between the element sections 111 and 112. The same is true for the antennas 130-2 and 130-4.

In the array antenna 10 in the seventh exemplary embodiment shown in FIG. 17, the antennas 130-1, 130-2, 130-3 and 130-4 are formed into a set to carry out feeding. In other words, the main cable 32 and the secondary cables 33, which are the feeding lines, may be connected as shown in FIG. 6C. Note that N=4.

In the pair of antennas 130 arranged in the horizontal direction (for example, the antennas 130-1 and 130-2), positions of the element sections 111 and 112 are reversed, to thereby reverse the feeding directions. Accordingly, it is possible to provide the array antenna 10 that radiates radio frequency to the + side in the horizontal direction (rightward in FIG. 17) and to the − side in the horizontal direction (leftward in FIG. 17). Note that the array antenna 10 is able to receive the radio frequency from the + side and the − side in the horizontal direction, owing to the reversibility of the antenna.

Here, the pairs of antennas 130 were laid in two tiers, but the number of tiers may be more than two, or may be only one. In the case of more than two, it may be possible to divide the plural antennas 130 into plural sets, provide the main cable 32 to each set and provide the secondary cables 33 branching off therefrom, to thereby carry out feeding. Note that the whole may be regarded as one set, without being divided into the plural sets.

Further, in the case of being divided into the plural sets, by supplying the transmission signals having different phases to each set, the radiating angle (beam tilt angle θ) of the radio frequency can be tilted from the horizontal plane toward the ground direction.

As described in the first exemplary embodiment, the input impedance of the antenna 130 can be set by changing the parameter for establishing the shape of the dipole antenna 110. Therefore, similar to the first exemplary embodiment, by setting the input impedance of the antenna 130 corresponding to the impedance of the secondary cable 33 and directly connecting the main cable 32 and the secondary cables 33 branching off therefrom, impedance matching is achieved. For this reason, it is possible to transmit and receive the radio frequency in the frequency range of the wide-band antenna 130.

### Eighth Exemplary Embodiment

The array antenna 10 in the first to seventh exemplary embodiments included the dipole antenna 110. The array antenna 10 in the eighth exemplary embodiment includes an antenna 140, which is a patch antenna, in place of the antenna 130 including the dipole antenna 110.

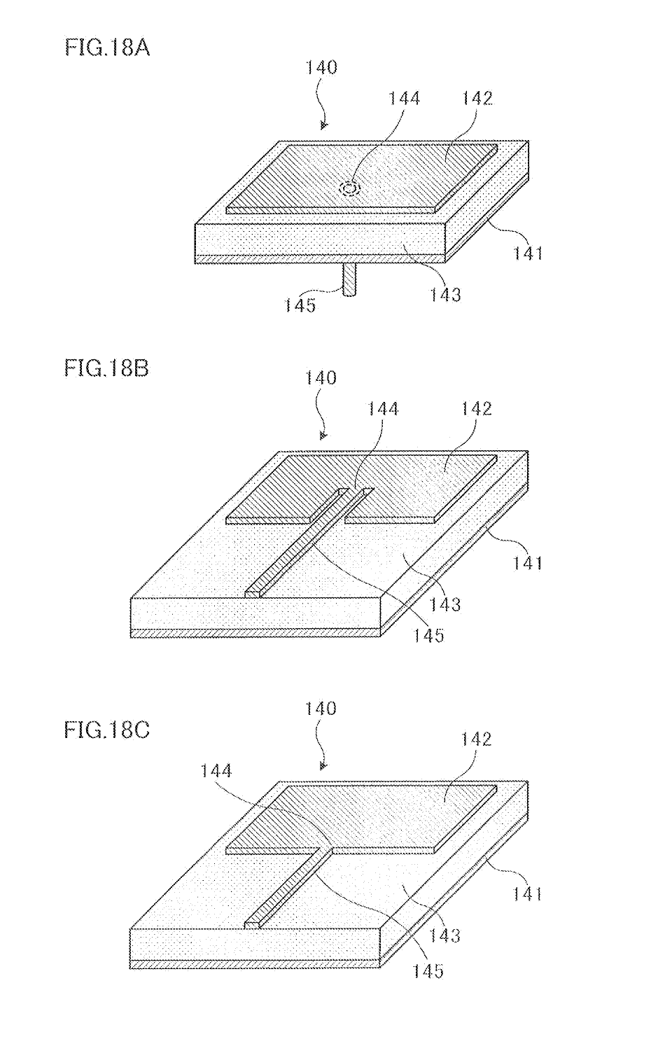

FIGS. 18A to 18C are diagrams illustrating a configuration of the antenna 140 in the eighth exemplary embodiment. In FIGS. 18A to 18C, how to feed the antenna 140, which is the patch antenna, is different.

Any of the antennas 140 shown in FIGS. 18A to 18C includes a ground plate section 141 as an example of the first conductor, a patch section 142 as an example of the second conductor, and an dielectric layer 143 sandwiched between the ground plate section 141 and the patch section 142. Note that both of the ground plate section 141 and the patch section 142 have rectangular planar shape, and are configured with metal having large electrical conductivity, such as copper or aluminum. The dielectric layer 143 is configured with, for example, polyimide or polytetrafluoroethylene. Note that an air layer may be provided instead of the dielectric layer 143.

In the antenna 140 shown in FIG. 18A, a feeding point 144, which is a position of feeding, is provided to a spot slightly deviated from the center of the patch section 142. Then, a feeding line 145 is provided to penetrate through the dielectric layer 143 and the ground plate section 141. The feeding line 145 in this case is configured with, for example, a rod of metal such as copper.

In the antenna 140 shown in FIG. 18B, the patch section 142 in the case of FIG. 18A is removed in a rectangular shape from a peripheral part of one side toward the center part. The feeding point 144 is provided to the removed part, and the feeding line 145 is provided from the feeding point. The feeding line 145 is provided on the dielectric layer 143 and constitutes a microstrip line together with the ground plate section 141. Note that the air layer may be provided instead of the dielectric layer 143.

In the antenna 140 shown in FIG. 18C, the feeding point 144 is provided to the center part of one side of the patch section 142 in the case of FIG. 18A, and the feeding line 145 is provided from the feeding point. The feeding line 145 is provided on the dielectric layer 143 and constitutes a microstrip line together with the ground plate section 141. Note that the air layer may be provided instead of the dielectric layer 143.

The antenna 140 shown in each of FIGS. 18A to 18C has different input impedance because the position of feeding to the patch section 142 is different. Of FIGS. 18A to 18C, the antenna 140 shown in FIG. 18A has the lowest input impedance, whereas the antenna 140 shown in FIG. 18C has the highest input impedance.

As described above, though the antenna 140, which is the patch antenna, is used instead of the antenna 130 including the dipole antenna 110, it is possible to set the input impedance by changing the shape of the antenna 140, such as the position of the feeding point 144 in the patch section 142.

Therefore, it may be possible to apply the antenna 140 in the eighth exemplary embodiment in place of the antenna 130 in the first exemplary embodiment.

### REFERENCE SIGNS LIST

1 . . . Base station antenna
2 . . . Cell
3-1 to 3-6 . . . Sector
4 . . . transceiver unit
10, 10-1 to 10-8 . . . Array antenna
11 . . . Main lobe
20 . . . tower
31 . . . Transmission and reception cable
32 . . . Main cable
33 . . . Secondary cable
110, 110-1 to 110-8 . . . Dipole antenna
111, 111a, 111b, 112, 112a, 112b . . . Element section
113, 114 . . . Leg section
115 . . . Stage section
120 . . . Reflector
120a . . . Front reflection section
120b . . . Side reflection section
130, 130-1 to 130-8, 140 . . . Antenna
141 . . . Ground plate section
142 . . . Patch section
200 . . . Phase shifter
300 . . . Quarter-wavelength transformer
500 . . . Radome

1-5. (canceled)

6. An array antenna comprising:
a first feeding line that has a first impedance and is configured with a cable;
N second feeding lines branching off from the first feeding line, each of which is configured with a cable or a strip line; and
N antennas, each of which has a second impedance that is set based on N times the first impedance, the N antennas being connected to the respective N second feeding lines,
wherein an impedance of each of the N second feeding lines substantially matches the second impedance of the antenna, and wherein N is an integer not less than 2.

7. The array antenna according to claim 6, wherein the antenna includes a dipole antenna having a pair of element sections, each of which is configured with a conductive material including a curved line at an edge thereof, the element sections being arranged at symmetrical positions with respect to a predetermined axis at a predetermined distance, and the second impedance is set by a shape of the dipole antenna.

8. The array antenna according to claim 7, wherein the antenna further includes another pair of element sections each configured with a conductive material including a curved line at an edge thereof, the element sections being arranged at symmetrical positions with respect to a predetermined axis at a predetermined distance, and the another pair of element sections is able to transmit and receive a polarization orthogonal to a polarization received and transmitted from and to the pair of element sections.

9. The array antenna according to claim 6, wherein the antenna includes a patch antenna having a first conductor, a second conductor and one of an dielectric or an air layer between the first conductor and the second conductor, and the second impedance is set by a position of feeding to the first conductor.

10. The array antenna according to claim 6, further comprising a radome that contains the array antenna.

11. The array antenna according to claims 7, further comprising a radome that contains the array antenna.

12. The array antenna according to claims 8, further comprising a radome that contains the array antenna.

13. The array antenna according to claims 9, further comprising a radome that contains the array antenna.
